(19) United States
(12) Patent Application Publication
(10) Pub. No.: US 2024/0362826 A1
(43) Pub. Date: Oct. 31, 2024

(54) SERVER DEVICE PROVIDING SOCIAL MEDIA PLATFORM WITH AI PROFILE PICTURE GENERATION

(71) Applicant: Lemon Inc., Grand Cayman (KY)

(72) Inventors: Zichun Wang, Culver City, CA (US); Xiaotong Ma, Beijing (CN); Kin Chung Wong, Los Angeles, CA (US); Jonathan Guzi, Culver City, CA (US); Jing Liu, Los Angeles, CA (US); Hao Qiu, Beijing (CN); Siqi Tan, Beijing (CN); Siyuan Chen, Beijing (CN)

(21) Appl. No.: 18/355,345

(22) Filed: Jul. 19, 2023

Related U.S. Application Data
(60) Provisional application No. 63/498,268, filed on Apr. 25, 2023.

(51) Int. Cl. G06T 11/00; G06F 3/0482

(52) U.S. Cl. CPC G06T 11/00; G06F 3/0482; G06Q 50/01; G06T 2200/24

(57) ABSTRACT

A server device provides a social media platform. The server device includes one or more processors configured to execute instructions stored in associated memory to send instructions to a client device to cause the client device to display a graphical user interface (GUI) of the social media platform, receive at least one image of a face of a user of the client device and a selection of at least one predetermined style via the GUI, using the at least one image and the at least one predetermined style as input, generate a plurality of artificial intelligence (AI) profile pictures via an AI model, and send the plurality of AI profile pictures to the client device.

### CROSS REFERENCE TO RELATED APPLICATIONS

This application claims priority to U.S. Provisional Patent App. No. 63/498,268, filed Apr. 25, 2023, the entirety of which is hereby incorporated herein by reference for all purposes.

### BACKGROUND

Social media platforms typically associate avatars, user icons, profile pictures, etc. with user accounts. These images differentiate users, which can be helpful when a user is adding another user to a network of friends, browsing through a list of users, or even identifying who is posting on the user's feed. Typically, a default icon is used when a user has not uploaded or selected a profile picture to be associated with their account, and some systems may allow a user to select from pre-set stock avatars. In particular, casual users of a social media platform may be less motivated to select an image or to take a picture of their own face to upload and share publicly. Lacking an identifying profile picture, such users with default icons may be less likely to form connections with other users and more likely to decrease use of the social media platform as a result. Thus, encouraging users to adopt a profile picture can increase user engagement and retention.

### SUMMARY

A server device providing a social media platform is provided herein. In one example, the server device includes one or more processors configured to execute instructions stored in associated memory to send instructions to a client device to cause the client device to display a graphical user interface (GUI) of the social media platform, and receive at least one image of a face of a user of the client device and a selection of at least one predetermined style via the GUI. The one or more processors are configured to, using the at least one image and the at least one predetermined style as input, generate a plurality of artificial intelligence (AI) profile pictures via an AI model, and send the plurality of AI profile pictures to the client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a computing system including a server device providing a social media platform.

FIG. 2 shows an example artificial intelligence (AI) model used by the server device of FIG. 1 to generate synthesized images.

FIG. 3 shows an example graphical user interface (GUI) of the social media platform of FIG. 1, displaying a user profile screen.

FIG. 4 shows an edit profile screen of the GUI.

FIG. 5 shows a profile picture generation introduction screen of the GUI.

FIG. 6 shows a style selection screen of the GUI.

FIG. 7 shows a profile picture generation status screen of the GUI.

FIG. 8 shows a profile picture selection screen of the GUI.

FIG. 9 shows the profile picture selection screen of FIG. 8, with additional AI profile pictures.

FIG. 10A shows an example frame displayed around a selected AI profile picture generated by the server device of FIG. 1.

FIG. 10B shows an example watermark displayed with the selected AI profile picture.

FIG. 11 shows a post featuring the selected AI profile picture, generated by the computing system of FIG. 1.

FIG. 12 shows an example new profile picture notification featuring the selected AI profile picture.

FIG. 13 shows a flowchart of a method for a social media platform.

FIG. 14 shows a schematic view of an example computing environment in which the computing system of FIG. 1 may be enacted.

### DETAILED DESCRIPTION

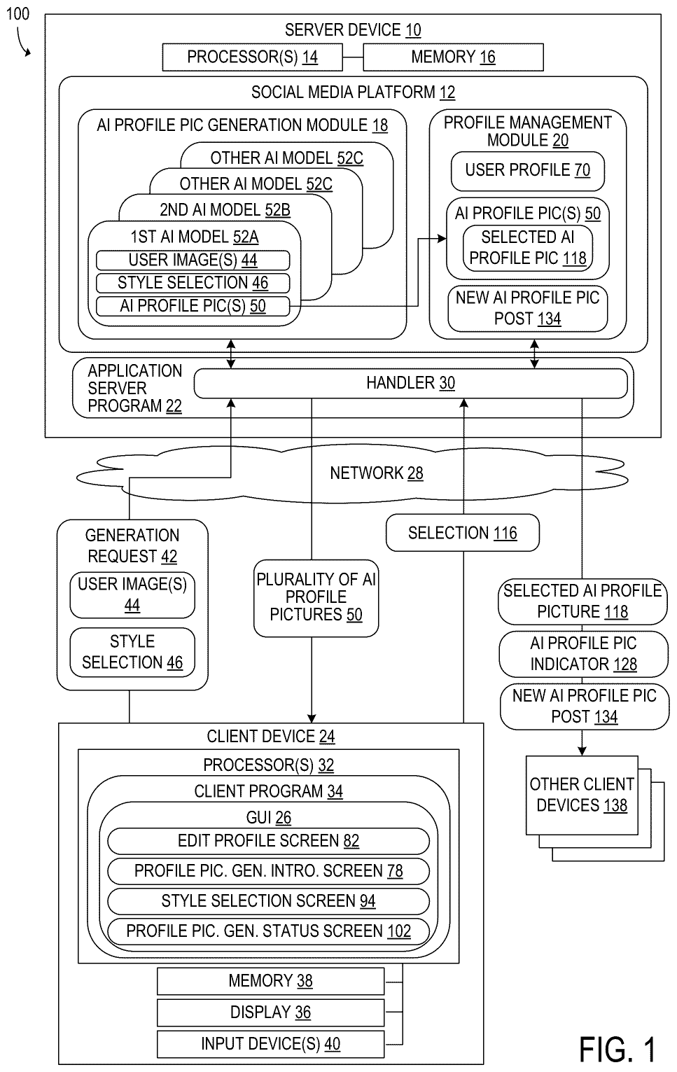

To address the issues described above, FIG. 1 illustrates a computing system 100 including a server device 10 providing a social media platform 12. The server device 10 comprises one or more processors 14 configured to execute instructions stored in associated memory 16 to implement various functions of the server device 10. The instructions may include, for example, an artificial intelligence (AI) profile picture generation module 18, a profile management module 20, and an application server program 22. The one or more processors 14 may be configured to send instructions to a client device 24 to cause the client device 24 to display a graphical user interface (GUI) 26 of the social media platform 12. The server device 10 and the client device 24 may be in communication with one another via a network 28 and one or more handler 30 of the application server program 22. The client device 24 may be a smartphone, tablet, personal computer, etc. including one or more processors 32 configured to execute a client program 34 to display the GUI 26 on a display 36, memory 38 for storing instructions, and one or more input devices 40 for receiving user input. It will be appreciated that the client program 34 may be a dedicated application for accessing the social media platform 12 or may alternatively be a general program such as an internet browser for accessing a content from a variety of server devices including the social media platform 12 from the server device 10. It will be further appreciated that the server device 10 may include multiple different servers working together to provide the social media platform 12, or may be one single server.

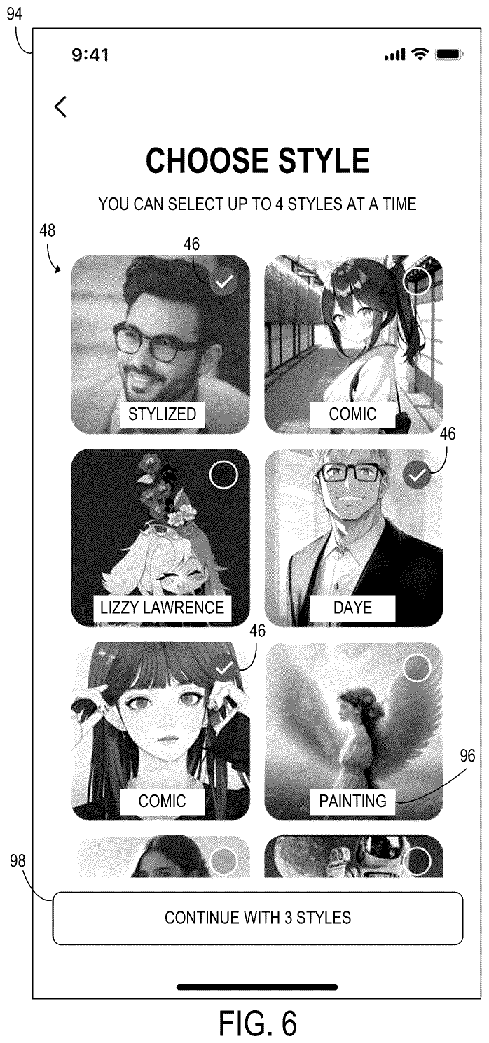

Briefly, the client device 24 may send a generation request 42 to the server device 10 seeking generation of AI profile pictures. The one or more processors 14 may be configured to receive the generation request 42, including at least one image 44 of a face of a user of the client device 24 and a selection 46 of at least one predetermined style 48 (see FIG. 6) via the GUI 26. Then, using the at least one image 44 and the at least one predetermined style 48 as input, the one or more processors 14 may be configured to generate a plurality of AI profile pictures 50 via an AI model, e.g., a first AI model 52A. In some implementations, the AI profile picture generation module 18 may include a plurality of models, but in other implementations, only one model may be used instead. In one implementation, the AI model is the first AI model 52A and the server device 10 may further include a second AI model 52B. In other implementations, the plurality of models additionally includes other AI models 52C. Finally, the one or more processors 14 may be configured to send the plurality of AI profile pictures 50 to the client device 24. The client device 24 may be configured to store the plurality of AI profile pictures 50 in a gallery of images, for example. In this manner, the user may be able to easily and quickly receive multiple synthesized images that the user can identify with, since images of the user are used as input, and adopt one or more of them as a profile or profile picture.

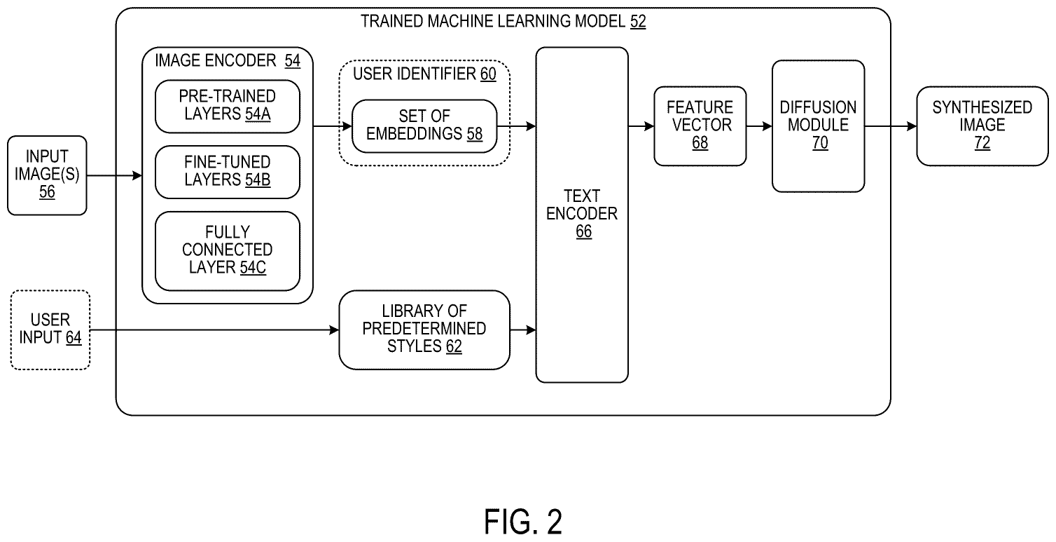

FIG. 2 shows an example AI model used by the server device of FIG. 1 to generate synthesized images. Any of the first AI model 52A, second AI model 52B, or other AI models 52C may be configured according to the illustrated example. The illustrated AI model is merely an example, and any suitable generative AI model may be used. Here, the example AI model is a trained machine learning model 52. An image encoder 54 is provided that has pre-trained layers 54A such as a pre-trained contrastive language-image pre-training (CLIP) vision transformer (ViT), fine-tuned layers 54B that are trained to extract visual features of the user from input images 56 such as the user image(s) 44 of the user's face in FIG. 1, and a fully connected layer 54C configured to generate a set of embeddings 58 based at least on the visual features of the face of the user extracted by the fine-tuned layers 54B. In some implementations, the set of embeddings 58 may be associated with a user identifier 60 of the user of the client device 24.

The trained machine learning model 52 may include a library 62 of predetermined templates of different sets of embeddings that describe different style and/or scene information, and may be configured to receive user input 64 selecting one or more styles, etc. from the library. The user input 64 and the set of embeddings 58 may be provided as input to a text encoder 66 and the text encoder 66 may generate an input feature vector 68 based at least on the user input 64 and the set of embeddings 58. This input feature vector 68 may be sent to a diffusion model 70 such as a Stable Diffusion model which is configured to generate a synthesized image 72 of the user based at least on the input feature vector 68.

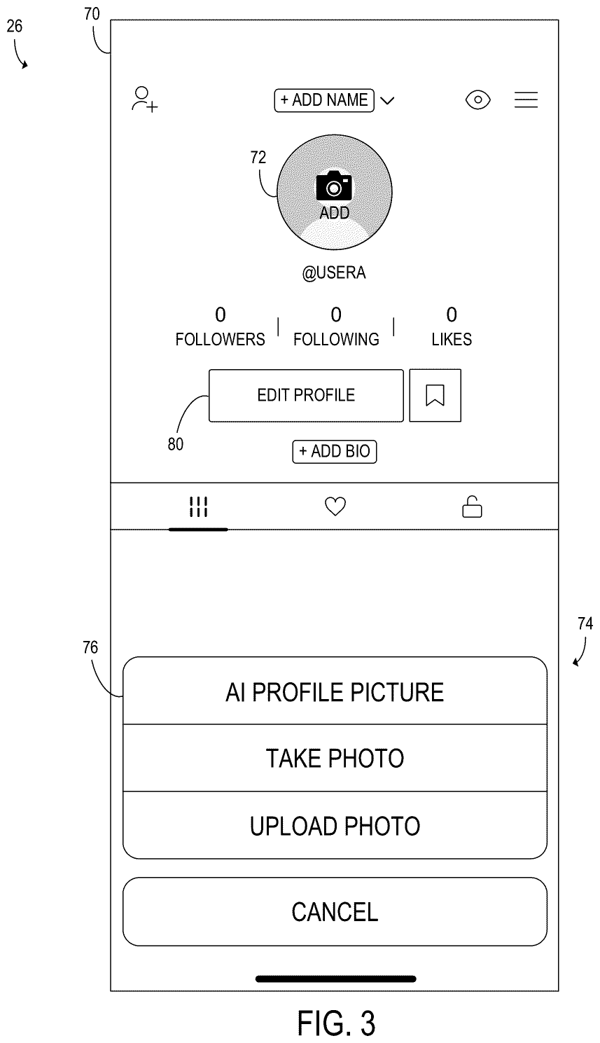

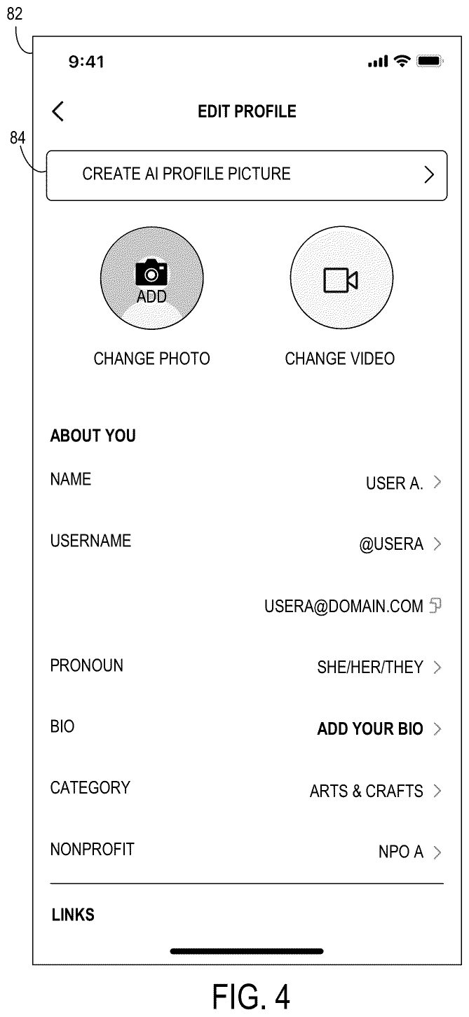

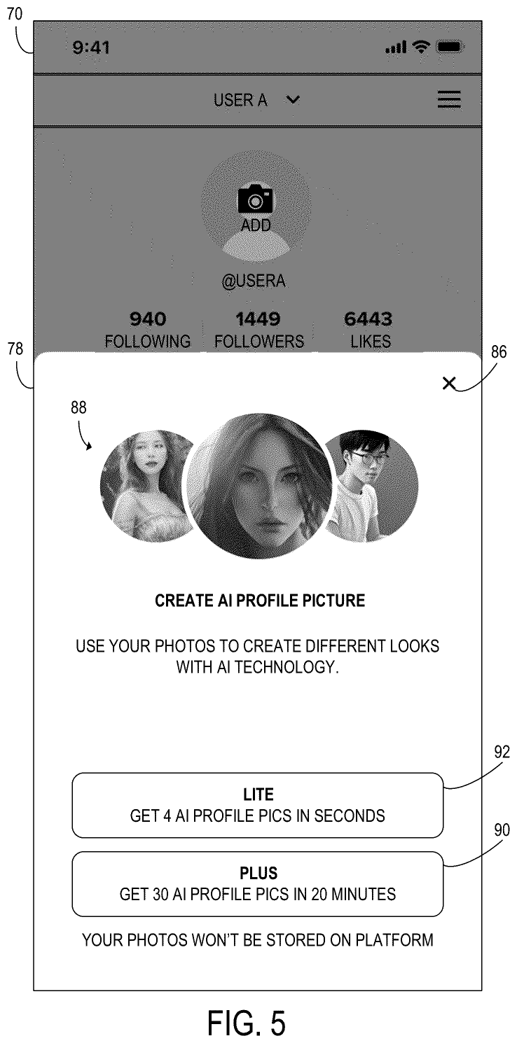

FIGS. 3-12 show various example screens and images displayed by the GUI 26 in relation to the generation of the AI profile pictures 50. In FIG. 3, the GUI 26 is displaying a user profile screen 70 of the user of the client device 24, User A. User A is a new user and does not have much information filled out in their profile yet. Further, User A has not uploaded or selected a profile picture, and therefore a default avatar 72 is displayed. One way to enter the AI profile picture generation process is through the user profile screen 70 and selecting an object such as the default avatar 72 itself or a separate button for changing the profile picture. Selecting the default avatar 72 or any currently used profile picture may trigger an instruction to edit the profile picture of the user. Then, a pull up list 74 may be displayed with different options for changing the default avatar 72, such as “upload photo,” “take photo,” and “AI profile picture.” Selecting an AI profile picture selector 76 may direct the user to a profile picture generation introduction screen 78, illustrated in FIG. 5. Thus, in one example, in response to the instruction to edit the profile picture of the user, the GUI 26 may display an entrance for generating the AI profile picture 50 (e.g., the profile picture generation introduction screen 78). Selecting an edit profile selector 80 may send an instruction to either the client program 34 or the profile management module 20 to open an edit profile screen 82 in the GUI 26, illustrated in FIG. 4.

Turning to FIG. 4, displayed are various features of the user's profile page that can be edited, such as the profile picture, name, username, etc. Similarly to FIG. 3, a create AI profile picture selector 84 may be displayed to direct the user to the profile picture generation introduction screen 78 of FIG. 5. In this manner, by placing entry points to the generation process at different locations throughout the GUI 26, interested users may choose to enter the process while viewing different screens and performing different tasks, and therefore more users overall may elect to try the AI profile picture generation.

Turning to FIG. 5, the profile picture generation introduction screen 78 of the GUI 26 is displayed. As one example, the profile picture generation introduction screen 78 may be a partial page or popup over another screen such as the user profile screen 70, or may instead be a full-page screen. The profile picture generation introduction screen 78 may include an exit selector 86 for the user to decline to proceed with the generation process. The profile picture generation introduction screen 78 screen may also include some example AI profile pictures 88, which may include professional examples chosen for advertising or an algorithmically chosen selection of AI profile pictures of friends or otherwise connected accounts of the user. The profile picture generation introduction screen 78 may explain information about the AI profile picture feature, such as that the user's photos are used to create different looks with AI technology, or a reassurance that the user's photos won't be stored on the social media platform 12. In addition, the profile picture generation introduction screen 78 may provide an option for the user to begin the process, that is, enter a procedure of generating the AI profile pictures 50.

In the depicted example, the AI profile picture generation module 18 utilizes the first AI model 52A and the second AI model 52B for two separate and different pathways. Here, the GUI 26 includes a first selector 90 (PLUS) to request generation of a first plurality of AI profile pictures (as the plurality of AI profile pictures 50) via the first AI model 52A and a second selector 92 (LITE) to request generation of a second plurality of AI profile pictures (as the plurality of AI profile pictures 50) via the second AI model 52B. The generation via the first AI model 52A is slower than the generation via the second AI model 52B, and the first plurality of AI profile pictures is greater than the second plurality of AI profile pictures. For example, the Plus pathway may use 5-10 user images 44 as input, finish generating the second plurality of AI profile pictures in about 20 minutes, and produce 4 images as output. In contrast, the Lite pathway may use a single user image 44 as input, finish generating the second plurality of AI profile pictures in less than 30 seconds, and produce 30 images as output. These are parameters that can be set in consideration of quality of images output, time found reasonable by the user base, and availability and cost of model resources, for example. The differences between the inputs and outputs of the two AI models 52A, 52B may be attributable to the first AI model 52A having a larger parameter size than the second AI model 52B. That is, the first AI model 52A may be more complex and therefore more likely to produce a desirable, high-quality outcome, but as a tradeoff, may utilize more resources and take longer to produce results. It will be appreciated that other differences between various models may be used to provide various options for the user, such as using models trained on different data sets and specializing in different types of outputs.

FIG. 6 shows a style selection screen 94 of the GUI 26. Responsive to receiving a selection of the first selector 90, the client device 24 may be configured to display the style selection screen 94 to proceed with the PLUS pathway. In the style selection screen 94, the GUI 26 may be configured to display a plurality of example images representing a plurality of the predetermined styles 48, and selection of at least one of the example images by the user may constitute the selection 46 of the at least one predetermined style 48. In the illustrated example, the user is permitted to select up to 4 styles. These styles will be input to the first AI model 52A as context (see FIG. 2) to influence the generated AI profile pictures 50. The LITE pathway may present the same styles, different styles, or no styles. Skipping the selection of styles by not presenting the style selection screen 94 to the user may allow the LITE pathway to be a relatively quick option to send results to impatient or low interest users, and encourage these users to adopt customized profile pictures when they would otherwise be likely to continue using the default avatar 72. It will be appreciated that while the example images are shown here with style names 96, the images may be presented without a text label in some embodiments. Responsive to receiving selection of a continue selector 98, the client device 24 may be configured to send the server device 10 the generation request 42 including the user images 44 and the style selection 46. Once received by the server device 10, the generation request 42 is input to the associated model (here, the first AI model 52A associated with the PLUS pathway).

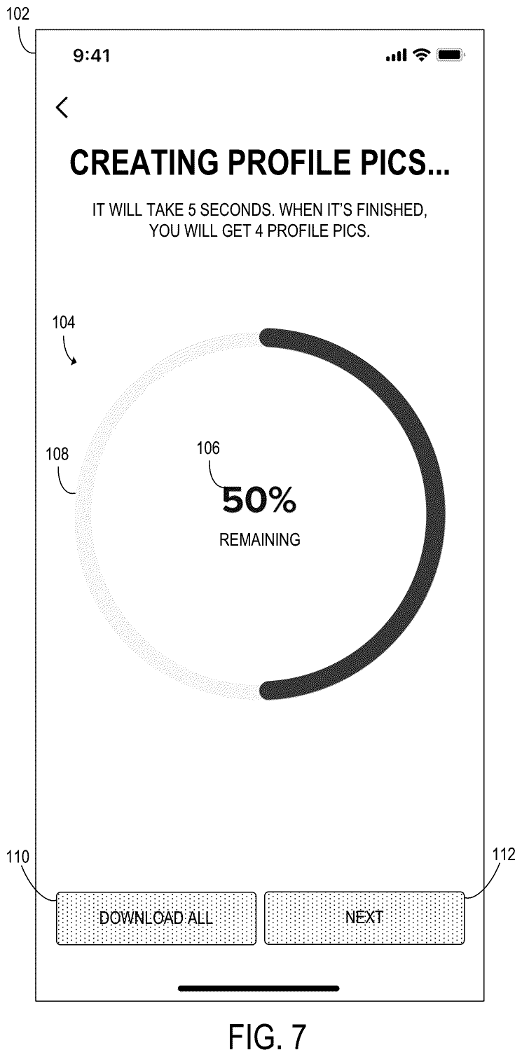

Once the server device 10 has begun profile picture generation with the selected model, an profile picture generation status screen 102 of the GUI 26 may be displayed on the client device 24, as shown in FIG. 7. The profile picture generation status screen 102 may include a progress meter 104 to inform the user of the generation progress. The progress meter 104 may include one or both of a progress text 106 stating the completion or remaining amount and a progress icon 108 that fills up as the generation progresses. The profile picture generation status screen 102 may additionally include information informing the user about what is currently happening, such as that profiles are currently being created, how long the process should take, and how many profile pictures will be produced. In the depicted example, rather than the PLUS pathway being selected in FIG. 5, the LITE pathway is selected. Thus, the user can expect to receive four profile pictures in about five seconds. When the progress is complete, the user can select a download all selector 110 to download all of the generated AI profile pictures 50. Additionally or alternatively, the user may select a next selector 112 to proceed to the next screen of the GUI 26. When the progress is at less than 100% completion, these selectors 110, 112 may be grayed out and unselectable, as illustrated.

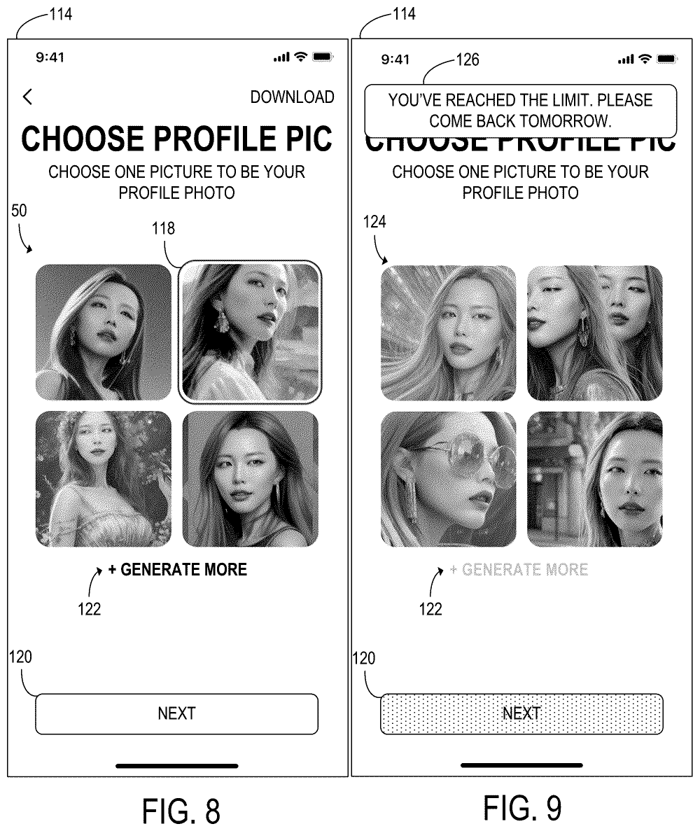

Upon receiving a selection of the next selector 112, the GUI 26 may be configured to display an profile picture selection screen 114 illustrated in FIGS. 8-9. Here, the user is instructed to select a desired profile photo. Thus, the one or more processors 14 may be further configured to, upon receiving selection 116 (see FIG. 1) of one 118 of the plurality of AI profile pictures 50 via the GUI 26, designate the selected AI profile picture 118 as a current profile picture of the user on the social media platform 12. This provides a simple way to allow the user to update their profile to replace the default avatar 72 or other current profile picture with a customized and relevant user profile picture. If the user is satisfied with the selected AI profile picture 118, then the user may proceed by selecting another next selector 120. However, if the user is not satisfied, then the GUI 26 may provide further options to fulfill the user's needs. For example, the one or more processors 14 may be configured to receive a request from the user for further generation, for example, by the user selecting a generate more selector 122. Responsive to receiving the request, the one or more processors 14 may be configured to generate an additional plurality of AI profile pictures 124 via the AI model (e.g., the first AI model 52A or the second AI model 52B), and send the additional plurality of AI profile pictures 124 to the client device 24. This may allow the model to try again to generate an acceptable image for the user without requiring the user to start over from the beginning of the process. In some implementations, the GUI 26 may allow the user to request the further generation up to a predetermined number of times, for example, two times for a total of three generation requests. The GUI 26 may be configured to display a limit warning 126 informing the user that no further regeneration requests remain and when new requests will become available. If the LITE pathway is chosen at first and the user does not select one of the generated AI profile pictures 50, then the GUI 26 may be configured to remind the user that the PLUS pathway is available as an alternative.

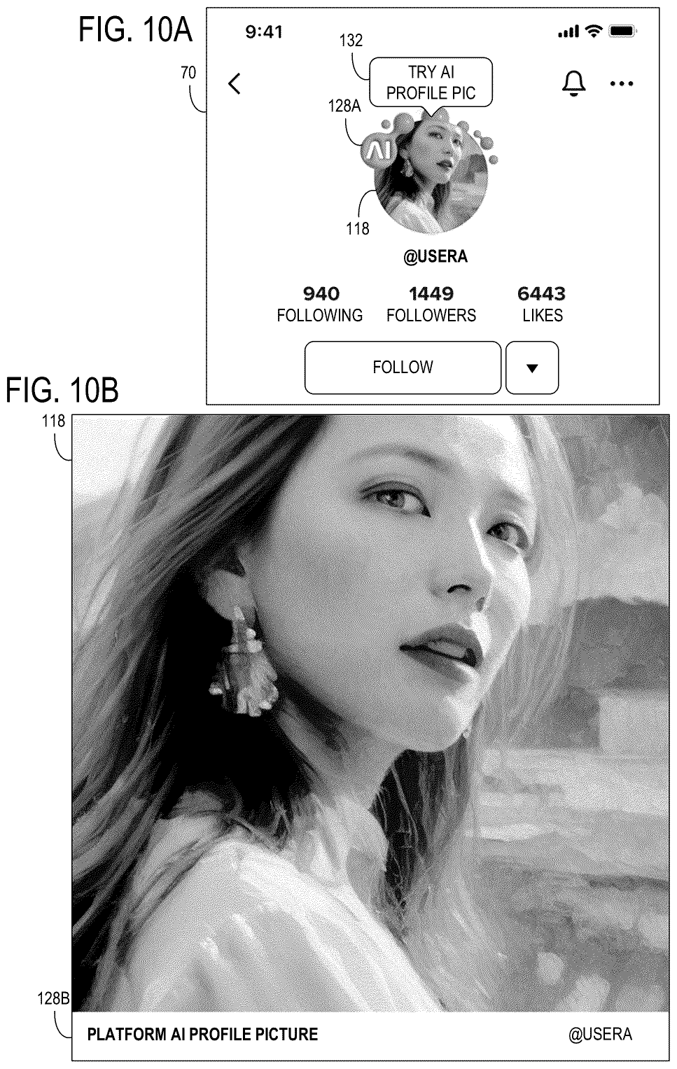

FIGS. 10A and 10B show example indicators displayed with the selected AI profile picture 118. It will be appreciated that the indicator can take many forms other than what is illustrated. For example, the GUI 26 may be configured to display the selected AI profile picture 118 with an AI profile picture indicator 128 such as a watermark 128B (see FIG. 10B) or frame 128A (see FIG. 10A) indicating that the selected AI profile picture 118 was generated with AI. These indicators may serve to advertise the AI profile picture generation feature to other users of the social media platform 12 and in some cases may provide clarification that the selected AI profile picture 118 is not a real photograph. As shown in FIG. 10A, the GUI 26 may additionally display a suggestion 132 that another user viewing User A's profile try the AI profile picture generation feature, including a link to a screen of the GUI 26 where the feature may be started. The watermark 128B and/or frame 128A may be displayed under the same or different circumstances, or permanently or for a limited time. For example, the watermark 128B may be part of the image itself of the selected AI profile picture 118 and always displayed together, or may be shown only when another user selects the selected AI profile picture 118 to be enlarged, when the selected AI profile picture 118 is included in a post on the social media platform 12, etc.

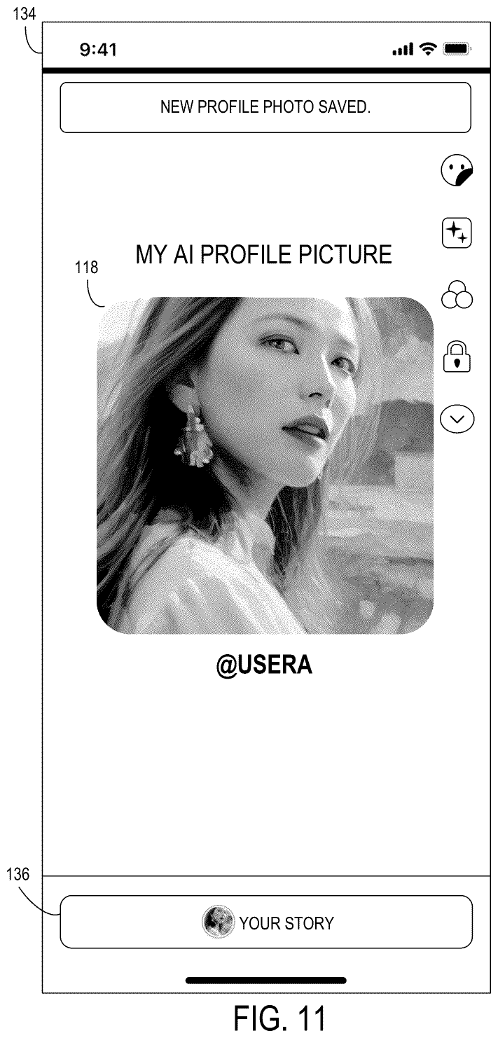

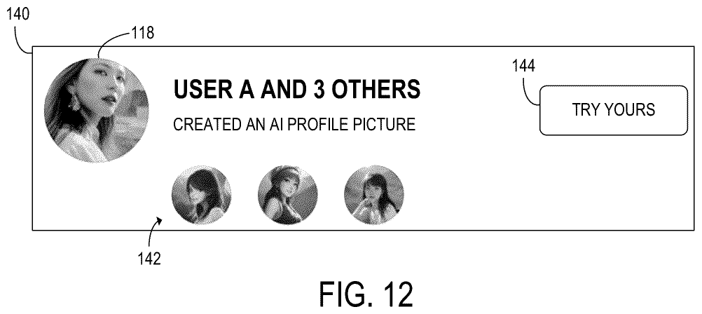

In some implementations, the GUI 26 may be configured to generate media content such as a post 134 under an account of the user featuring the selected AI profile picture 118, as shown in FIG. 11. The post 134 may be automatically generated and posted upon confirmation of the selection 116 of the selected AI profile picture 118 as the user's profile photo, or may only be generated and presented to the user for further edits and confirmation before posting. In the latter case, the user may be able to confirm and post the profile picture announcement to the user's “story” by selecting a your story selector 136. Other users on other client devices 138 may be able to view this post and the selected AI profile picture 118, once posted, and may be inspired to try the AI profile picture generation feature themselves. Similar announcements may be presented in various forms throughout the social media platform 12. For example, FIG. 12 shows a new profile picture notification 140 featuring the selected AI profile picture 118. The notification 140 may be presented in a notifications pane, placed between posts in a user's feed, or presented at other location. In some instances, the notification 140 may include multiple AI profile pictures 142 of one or more different users who are contacts with the viewing user. The notification 140 may further include a try yours selector 144 including a link to direct the user to the profile picture generation introduction screen 78 of FIG. 5. Thus, the client program 34 or profile management 20 may be configured to, in response to the replacement of the previous user profile picture with the selected AI profile picture 118, generate media content such as the post 134 according to the selected AI profile picture 118. Alternatively, the client program 34 or profile management 20 may be configured to, after generating the at least one AI profile picture 50, generate media content such as the post 134, based on the least one AI profile picture 50. Other generated media content may include, for example, the indicators 128 of FIGS. 10A-B or the notification 140.

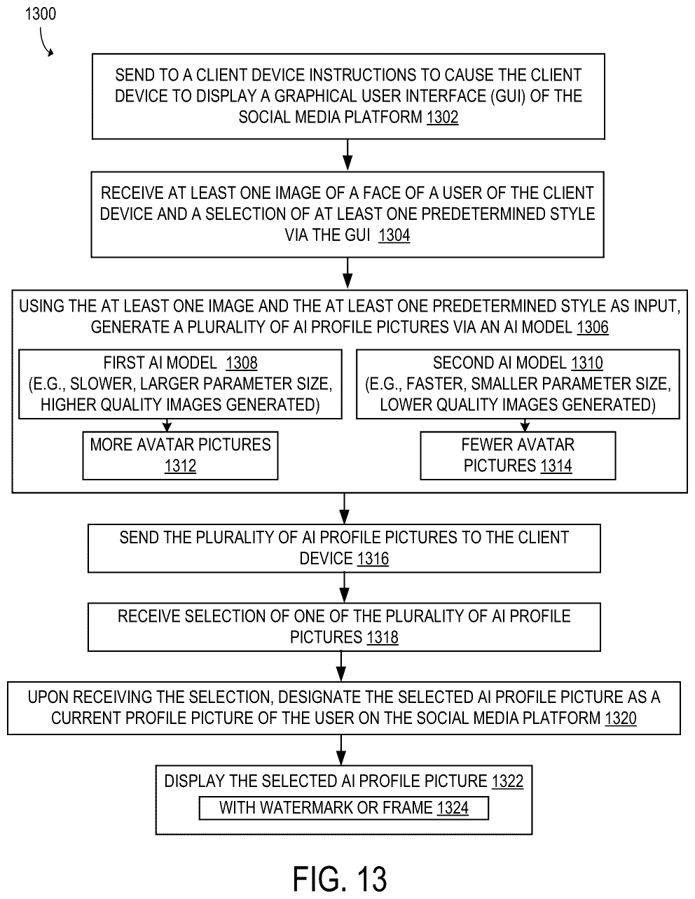

FIG. 13 shows a flowchart for a method 1300 for a social media platform according to the present disclosure. The method 1300 may be implemented by the computing system 100 illustrated in FIG. 1. At 1302, the method 1300 may include sending instructions to a client device to cause the client device to display a graphical user interface (GUI) of the social media platform. At 1304, the method 1300 may include receiving at least one image of a face of a user of the client device and a selection of at least one predetermined style via the GUI. At 1302, the method 1300 may include, using the at least one image and the at least one predetermined style as input, generating a plurality of artificial intelligence (AI) profile pictures via an AI model. In this manner, the user can receive multiple AI-generated images that the user may feel less self-conscious about using than they would about a real picture, while still being able to relate to the profile picture s since they were generating using the user's own face as input. In some implementations, the GUI may be configured to display a plurality of example images representing a plurality of predetermined styles, and selection of at least one of the example images by the user may constitute the selection of the at least one predetermined style. This may provide an easy and intuitive way for the user to choose a style that is likely to result in an acceptable output.

At 1308, the AI model may be a first AI model, and the GUI may include a first selector to request generation of a first plurality of AI profile pictures via the first AI model and a second selector to request generation of a second plurality of AI profile pictures via a second AI model. Alternatively, at 1310, the AI model may be a second AI model. The generation via the first AI model may be slower than the generation via the second AI model, and the first plurality of AI profile pictures is greater than the second plurality of AI profile pictures. This may be because the first AI model has a larger parameter size than the second AI model. Thus, at 1312, use of the first AI model may result in more profile pictures, while at 1314, use of the second AI model may result in fewer profile pictures. However, other differences between models may be utilized. By providing at least these two different pathways, users can self-select based on their own preference and level of interest whether to spend more time for better results or sacrifice quality for a quick turnaround. In some implementations, the method may further comprise, responsive to receiving a request from the user for further generation, generating an additional plurality of AI profile pictures via the AI model, and sending the additional plurality of AI profile pictures to the client device. Then, at 1316, the method 1300 may include sending the plurality of AI profile pictures to the client device.

At 1318, the method 1300 may include, upon receiving selection of one of the plurality of AI profile pictures via the GUI, designating the selected AI profile picture as a current profile picture of the user on the social media platform. This may increase the proportion of users on the social media platform with recognizable and useful user profile pictures associated with their profiles and accounts. Accordingly, at 1322, the method may include the GUI being configured to display the selected AI profile picture, and at 1324, the selected profile picture may be displayed to other users with a watermark or frame indicating that the selected AI profile picture was generated with AI. This may serve to advertise the AI profile picture generation feature to other users who may be interested. Another way to draw in more interested users is if the GUI is configured to generate a post under an account of the user featuring the selected AI profile picture.

In some embodiments, the methods and processes described herein may be tied to a computing system of one or more computing devices. In particular, such methods and processes may be implemented as a computer-application program or service, an application-programming interface (API), a library, and/or other computer-program product.

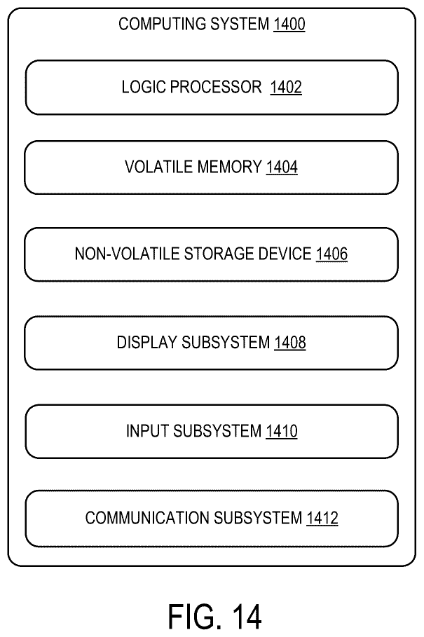

FIG. 14 schematically shows a non-limiting embodiment of a computing system 1400 that can enact one or more of the methods and processes described above. Computing system 1400 is shown in simplified form. Computing system 1400 may embody the computer device 10 described above and illustrated in FIG. 2. Computing system 1400 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 1400 includes a logic processor 1402 volatile memory 1404, and a non-volatile storage device 1406. Computing system 1400 may optionally include a display subsystem 1408, input subsystem 1410, communication subsystem 1412, and/or other components not shown in FIG. 14.

Logic processor 1402 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 1402 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1406 includes one or more physical devices configured to hold instructions executable by the logic processors to implement the methods and processes described herein. When such methods and processes are implemented, the state of non-volatile storage device 1406 may be transformed—e.g., to hold different data.

Non-volatile storage device 1406 may include physical devices that are removable and/or built-in. Non-volatile storage device 1406 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 1406 may include nonvolatile, dynamic, static, read/write, read-only, sequential-access, location-addressable, file-addressable, and/or content-addressable devices. It will be appreciated that non-volatile storage device 1406 is configured to hold instructions even when power is cut to the non-volatile storage device 1406.

Volatile memory 1404 may include physical devices that include random access memory. Volatile memory 1404 is typically utilized by logic processor 1402 to temporarily store information during processing of software instructions. It will be appreciated that volatile memory 1404 typically does not continue to store instructions when power is cut to the volatile memory 1404.

Aspects of logic processor 1402, volatile memory 1404, and non-volatile storage device 1406 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1400 typically implemented in software by a processor to perform a particular function using portions of volatile memory, which function involves transformative processing that specially configures the processor to perform the function. Thus, a module, program, or engine may be instantiated via logic processor 1402 executing instructions held by non-volatile storage device 1406, using portions of volatile memory 1404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1408 may be used to present a visual representation of data held by non-volatile storage device 1406. The visual representation may take the form of a graphical user interface (GUI). As the herein described methods and processes change the data held by the non-volatile storage device, and thus transform the state of the non-volatile storage device, the state of display subsystem 1408 may likewise be transformed to visually represent changes in the underlying data. Display subsystem 1408 may include one or more display devices utilizing virtually any type of technology. Such display devices may be combined with logic processor 1402, volatile memory 1404, and/or non-volatile storage device 1406 in a shared enclosure, or such display devices may be peripheral display devices.

When included, input subsystem 1410 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1412 may be configured to communicatively couple various computing devices described herein with each other, and with other devices. Communication subsystem 1412 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 1400 to send and/or receive messages to and/or from other devices via a network such as the Internet.

The following paragraphs provide additional description of the subject matter of the present disclosure. One aspect provides a server device providing a social media platform, and the server device includes one or more processors configured to execute instructions stored in associated memory. The one or more processors of the server device are configured to send instructions to a client device to cause the client device to display a graphical user interface (GUI) of the social media platform, and receive at least one image of a face of a user of the client device and a selection of at least one predetermined style via the GUI. The one or more processors are further configured to, using the at least one image and the at least one predetermined style as input, generate a plurality of artificial intelligence (AI) profile pictures via an AI model, and send the plurality of AI profile pictures to the client device. In this aspect, additionally or alternatively, the AI model can be a first AI model and the server device can further include a second AI model, the GUI can include a first selector to request generation of a first plurality of AI profile pictures via the first AI model and a second selector to request generation of a second plurality of AI profile pictures via the second AI model. In this aspect, additionally or alternatively, the generation via the first AI model can be faster than the generation via the second AI model, and the first plurality of AI profile pictures can be fewer than the second plurality of AI profile pictures. In this aspect, additionally or alternatively, the first AI model can have a larger parameter size than the second AI model. In this aspect, additionally or alternatively, the one or more processors can be further configured to, upon receiving selection of one of the plurality of AI profile pictures via the GUI, designate the selected AI profile picture as a current profile picture of the user on the social media platform. In this aspect, additionally or alternatively, the GUI can be configured to display the selected AI profile picture with a watermark or frame indicating that the selected AI profile picture was generated with AI. In this aspect, additionally or alternatively, the GUI can be configured to generate a post under an account of the user featuring the selected AI profile picture. In this aspect, additionally or alternatively, the GUI can be configured to display a plurality of example images representing a plurality of predetermined styles, and selection of at least one of the example images by the user can constitute the selection of the at least one predetermined style. In this aspect, additionally or alternatively, the one or more processors can be configured to, responsive to receiving a request from the user for further generation: generate an additional plurality of AI profile pictures via the AI model, and send the additional plurality of AI profile pictures to the client device. In this aspect, additionally or alternatively, the GUI can be configured to allow the user to request the further generation up to a predetermined number of times.

Another aspect provides a method for a social media platform, comprising sending instructions to a client device to cause the client device to display a graphical user interface (GUI) of the social media platform, and receiving at least one image of a face of a user of the client device and a selection of at least one predetermined style via the GUI. The method further comprises using the at least one image and the at least one predetermined style as input, generating a plurality of artificial intelligence (AI) profile pictures via an AI model, and sending the plurality of AI profile pictures to the client device. In this aspect, additionally or alternatively, the AI model can be a first AI model, and the GUI can includes a first selector to request generation of a first plurality of AI profile pictures via the first AI model and a second selector to request generation of a second plurality of AI profile pictures via a second AI model. In this aspect, additionally or alternatively, the generation via the first AI model can be faster than the generation via the second AI model, and the first plurality of AI profile pictures can be fewer than the second plurality of AI profile pictures. In this aspect, additionally or alternatively, the first AI model can have a larger parameter size than the second AI model. In this aspect, additionally or alternatively, the method may further comprise, upon receiving selection of one of the plurality of AI profile pictures via the GUI, designating the selected AI profile picture as a current profile picture of the user on the social media platform. In this aspect, additionally or alternatively, the GUI can be configured to display the selected AI profile picture with a watermark or frame indicating that the selected AI profile picture was generated with AI. In this aspect, additionally or alternatively, the GUI can be configured to generate a post under an account of the user featuring the selected AI profile picture. In this aspect, additionally or alternatively, the GUI can be configured to display a plurality of example images representing a plurality of predetermined styles, and selection of at least one of the example images by the user constitutes the selection of the at least one predetermined style. In this aspect, additionally or alternatively, the method may further comprise, responsive to receiving a request from the user for further generation, generating an additional plurality of AI profile pictures via the AI model, and sending the additional plurality of AI profile pictures to the client device.

Another aspect provides a client device for accessing a social media platform. The client device comprises one or more processors configured to execute instructions stored in associated memory to display a graphical user interface (GUI) of the social media platform, send at least one image of a face of a user of the client device and a selection of at least one predetermined style via the GUI to a server device including an artificial intelligence (AI) model, and receive, from the server device, a plurality of AI profile pictures generated via the AI model using the at least one image and the at least one predetermined style as input.

Another aspect provides a method for generating an AI profile picture of a social media platform user. The method comprises displaying a graphical user interface (GUI) of the social media platform, in response to an instruction of editing a profile picture of a user, displaying an entrance for generating the AI profile picture, and entering a procedure of generating the AI profile picture. The procedure comprises receiving a first input of at least one image of a face of the user and a second input of at least one style, and generating at least one AI profile picture via an artificial intelligence (AI) model based on the at least one image and the at least one predetermined style. The method further comprises receiving a selection of the AI profile picture from the at least one AI profile picture, and replacing a profile picture of the user to be the selected AI profile picture. In this aspect, additionally or alternatively, the method may further comprise, in response to the replacement, generating media content according to the selected AI profile picture. In this aspect, additionally or alternatively, the method may further comprise, after generating the at least one AI profile picture, generating media content based on the least one AI profile picture. In this aspect, additionally or alternatively, the media content may include a link to generate an AI profile picture for another user.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

An appendix is attached further describing embodiments of the present disclosure.

1. A server device providing a social media platform, the server device comprising:
one or more processors configured to execute instructions stored in associated memory to:
send instructions to a client device to cause the client device to display a graphical user interface (GUI) of the social media platform;
receive at least one image of a face of a user of the client device and a selection of at least one predetermined style via the GUI;
using the at least one image and the at least one predetermined style as input, generate a plurality of artificial intelligence (AI) profile pictures via an AI model; and
send the plurality of AI profile pictures to the client device.

2. The server device of claim 1, wherein
the AI model is a first AI model and the server device further includes a second AI model,
the GUI includes a first selector to request generation of a first plurality of AI profile pictures via the first AI model and a second selector to request generation of a second plurality of AI profile pictures via the second AI model.

3. The server device of claim 2, wherein the generation via the first AI model is slower than the generation via the second AI model, and the first plurality of AI profile pictures is greater than the second plurality of AI profile pictures.

4. The server device of claim 2, wherein the first AI model has a larger parameter size than the second AI model.

5. The server device of claim 1, wherein the one or more processors are further configured to, upon receiving selection of one of the plurality of AI profile pictures via the GUI, designate the selected AI profile picture as a current profile picture of the user on the social media platform.

6. The server device of claim 1, wherein the GUI is configured to display the selected AI profile picture with a watermark or frame indicating that the selected AI profile picture was generated with AI.

7. The server device of claim 1, wherein the GUI is configured to generate a post under an account of the user featuring the selected AI profile picture.

8. The server device of claim 1, wherein the GUI is configured to display a plurality of example images representing a plurality of predetermined styles, and selection of at least one of the example images by the user constitutes the selection of the at least one predetermined style.

9. The server device of claim 1, wherein the one or more processors are configured to, responsive to receiving a request from the user for further generation:
generate an additional plurality of AI profile pictures via the AI model; and
send the additional plurality of AI profile pictures to the client device.

10. The server device of claim 1, wherein the GUI allows the user to request the further generation up to a predetermined number of times.

11. A method for a social media platform, the method comprising:
sending instructions to a client device to cause the client device to display a graphical user interface (GUI) of the social media platform;
receiving at least one image of a face of a user of the client device and a selection of at least one predetermined style via the GUI;
using the at least one image and the at least one predetermined style as input, generating a plurality of artificial intelligence (AI) profile pictures via an AI model; and
sending the plurality of AI profile pictures to the client device.

12. The method of claim 11, wherein
the AI model is a first AI model, and
the GUI includes a first selector to request generation of a first plurality of AI profile pictures via the first AI model and a second selector to request generation of a second plurality of AI profile pictures via a second AI model.

13. The method of claim 11, wherein the generation via the first AI model is slower than the generation via the second AI model, and the first plurality of AI profile pictures is greater than the second plurality of AI profile pictures.

14. The method of claim 11, wherein the first AI model has a larger parameter size than the second AI model.

15. The method of claim 11, further comprising, upon receiving selection of one of the plurality of AI profile pictures via the GUI, designating the selected AI profile picture as a current user profile of the user on the social media platform.

16. The method of claim 11, wherein the GUI is configured to display the selected AI profile picture with a watermark or frame indicating that the selected AI profile picture was generated with AI.

17. The method of claim 11, wherein the GUI is configured to generate a post under an account of the user featuring the selected AI profile picture.

18. The method of claim 11, wherein the GUI is configured to display a plurality of example images representing a plurality of predetermined styles, and selection of at least one of the example images by the user constitutes the selection of the at least one predetermined style.

19. The method of claim 11, further comprising, responsive to receiving a request from the user for further generation:
generating an additional plurality of AI profile pictures via the AI model; and
sending the additional plurality of AI profile pictures to the client device.

20. A client device for accessing a social media platform, the client device comprising:
one or more processors configured to execute instructions stored in associated memory to:
display a graphical user interface (GUI) of the social media platform;
send at least one image of a face of a user of the client device and a selection of at least one predetermined style via the GUI to a server device including an artificial intelligence (AI) model; and
receive, from the server device, a plurality of AI profile pictures generated via the AI model using the at least one image and the at least one predetermined style as input.

21. A method for generating an AI profile picture of a social media platform user, the method comprising:
displaying a graphical user interface (GUI) of the social media platform;
in response to an instruction of editing a profile picture of a user, displaying an entrance for generating the AI profile picture;
entering a procedure of generating the AI profile picture, comprising:
receiving a first input of at least one image of a face of the user and a second input of at least one style;
generating at least one AI profile picture via an artificial intelligence (AI) model based on the at least one image and the at least one predetermined style;
receiving a selection of the AI profile picture from the at least one AI profile picture; and
replacing a profile picture of the user to be the selected AI profile picture.

22. The method of claim 21, further comprising, in response to the replacement, generating media content according to the selected AI profile picture.

23. The method of claim 21, further comprising, after generating the at least one AI profile picture, generating media content based on the least one AI profile picture.

24. The method of claim 22, wherein the media content includes a link to generate an AI profile picture for another user.

25. A non-transitory computer-readable storage medium having thereon stored a computer program which when executed by a processor, implements the video processing method according to claim 11.

26. A non-transitory computer-readable storage medium having thereon stored a computer program which when executed by a processor, implements the video processing method according to claim 21.
